(19) United States
(12) Patent Application Publication
(10) Pub. No.: US 2026/0100025 A1
(43) Pub. Date: Apr. 9, 2026

(54) METHOD AND SYSTEM FOR PRODUCING A TRAINING DATA SET BASED UPON CAMERA IMAGES

(71) Applicant: AUMOVIO Autonomous Mobility Germany GmbH, Ingolstadt (DE)

(72) Inventors: Peter Mati, Budapest (HU); Balázs Péter Taranyi, Pécs (HU)

(21) Appl. No.: 19/351,504

(22) Filed: Oct. 7, 2025

(30) Foreign Application Priority Data
Oct. 9, 2024 (DE) 10 2024 209 842.6

(51) Int. Cl. G06V 10/774; G06T 5/77; G06T 15/10; G06V 10/82; G06V 20/56

(52) U.S. Cl. CPC G06V 10/774; G06T 5/77; G06T 15/10; G06V 10/82; G06T 2207/10028; G06T 2207/20081; G06T 2207/20084; G06T 2207/30252; G06V 20/56

(57) ABSTRACT

The present invention is concerned with approaches for producing a training data set (TD) based on an input training data set (ITD) comprising multiple input training images (Iᵢ) obtained from at least one sensor.

### CROSS REFERENCES TO RELATED APPLICATIONS

This application claims the benefit and/or priority to German application 10 2024 209 842.6 filed Oct. 9, 2024, the content of which is incorporated by reference herein in its entirety.

### TECHNICAL FIELD

The present invention is concerned with methods, in particular computer-implemented methods, for producing training data sets based on an input training data sets comprising multiple images obtained from a camera. The present invention also comprises computer programs and computer-readable (storage) mediums that store instructions that perform these methods.

### BACKGROUND

The field of machine learning is concerned with algorithms capable of making predictions based on input data and thus refer to data driven models. The underlying algorithms frequently are set up based on training data sets via which the model's parameters are initially fit. This is referred to as the training phase. In case of supervised learning procedures by utilizing optimization methods.

The training data sets consist of a set of input data examples together with targets or labels which refer to what is contained in the input data, e.g., object classes of objects. The input data is processed through the machine learning model, e.g., a neural network, and the results produced are compared with the labels. By means of the comparison and the specific learning algorithm applied, the parameters of the model-in case of a neural network weights of connections between neurons-are adjusted. One of the goals of such training phase is to obtain a trained model that is capable of generalizing to new unknown data with high precision.

In order to set up machine learning models that are capable of performing their tasks with high accuracy, large amounts of different types of training data covering various scenarios are needed. In order to increase training data sets, one option is to apply data augmentation techniques, which refer to the addition of slightly modified copies of training data set examples created using the existing data. The augmentations for instance comprise two dimensional (2D) image transformations, especially geometrical transformations, the addition of noise or color aberrations and many more. The data augmentations are also used to increase the robustness of the respective machine learning model during training. The data augmentation, however, is typically applied during training only and used, e.g., to prevent overfitting, to increase the number of available training data set examples.

### BRIEF DESCRIPTION OF DRAWINGS

This description includes drawings, wherein:

FIG. 1 shows a first preferred embodiment of the method according to the present invention;

FIG. 2 illustrates a second preferred embodiment of the method according to the present invention; and

FIG. 3A, FIG. 3B, FIG. 3C, and FIG. 3D show examples of input training images and corresponding training data images.

In the figures, the same elements are always provided with the same reference symbols.

### DETAILED DESCRIPTION

For different scenarios and/or applications of the same machine learning model, typically completely different training data sets are needed. Especially, if a machine learning model is used for perception tasks, the training data sets need to be adapted to the specific perception situation, for instance to the sensors used to sense the environment, to their location and to various further environmental parameters. However, the collection and processing of image-based training data sets is labor and time intensive and costly.

Thus, it is an object of the present invention to improve the availability of different training data sets for machine learning models.

This object is achieved by the method according to claim 1, its advantageous use according to claim 13, the computer program according to claim 14 and the computer-readable (storage) medium according to claim 15.

With regards to the method, the objective technical problem is solved by a method, in particular, a computer-implemented method, for producing a training data set based on an input training data set comprising multiple input training images obtained from a sensor, e.g., a camera or another environmental sensor. The input training data set may as well be collected using multiple sensors of the same type or of different types.

For each input training image of the input training data set, the method comprises the steps of:
determining a depth map corresponding to the input training image, and determining a three-dimensional point cloud based on the depth map;
choosing at least one first virtual pose for the sensor which is different to a base pose which corresponds to a pose of the sensor for recording the input training data set;
projecting the point cloud to a virtual image corresponding to the first virtual pose;
determining at least one image area of the virtual image with missing or insufficient point cloud information, and replacing the at least one determined image area by a replacement image area generated by using a generative image generation model;
obtaining a training data image of the training data set by using an image rendering model based on the virtual image.

The input training data set comprises multiple images, which may or may not be equipped with corresponding indications or labels. It is also possible that parts of the input training data set comprise labels, and other parts do not comprise labels. The images may be recorded by using one or multiple sensors. In case of an advanced driver assistance system (ADAS) application, the sensor(s) may be mounted on a vehicle.

The training data images produced from the input training data set according to the suggested method form a new training data set that can be used for training of a machine learning model, preferably a machine learning model comprising at least one neural network.

The new training data set obtained by carrying out the suggested method corresponds to a predefined or chosen virtual sensor pose different from a pose of the sensor used to collect the input training data set. In particular, the training data set may differ from the input training data set with respect to a perspective or a height of the sensor. In that case, the present invention allows to generate a training data set with varying perspective and/or height without changing a position of the sensor used to collect the input training data set and without recollecting data by means of the sensor.

Thus, the present invention allows to obtain training data for different scenarios and may be used to adopt machine learning models to the different scenarios without the need of collecting new training data for that purpose. The method may also be used to extend existing training data sets. It is an advantage of the present invention that three dimensional (3D) geometrical transformations may be carried out with respect to the input training data set.

According to one embodiment of the method, the depth map is determined by additionally taking into account an input point cloud dataset corresponding to the input training data set. The input point cloud data set may be recorded together with the input training dataset. For instance, the input point cloud data set may be obtained from at least one radar, ultrasonic or LiDAR sensor.

Preferably, the 3D point cloud is determined by further taking into account intrinsic parameters of the sensor.

It is of advantage, if the suggested method further comprises the step of applying an inpainting process to the virtual image and/or to the training data image. The inpainting process may be based on a denoising diffusion probabilistic model, as, e.g., described in “RePaint: Inpainting using Denoising Diffusion Probabilistic Models” by A. Lugmayr et al., available on arXiv, doi: arXiv:2201.09865.

The depth model in principle may be any depth model available in the state of the art. However, preferably a depth anything model is used, especially the depth anything v2 model, which was suggested by L. Yang et al in “Depth Anything V2”, available on arXiv, doi: arXiv:2406.09414v1.

In a preferred embodiment of the suggested method, the depth model, the image generation model, the image rendering model and/or the data annotation model comprises/comprise at least one neural network.

Preferably, the image generation model is a latent variable generative model, preferably a score-based generative model such as a stable diffusion model. For instance, the image generation model may be based on a diffusion probabilistic model, as suggested by J. Sohl-Dickstein et al in “Deep Unsupervised Learning using Nonequilibrium Thermodynamics” in 2023, available on arXiv, doi:arXiv: 1503.03585, a noise-conditioned score network, as suggested by Y. Song et al in “Generative Modeling by Estimating Gradients of the Data Distribution” in 2019, available on arXiv, doi:arXiv: 1907.05600, or a denoising diffusion probabilistic model, as suggested by J. Ho et al. in “Denoising Diffusion Probabilistic Models” in 2020, also available on arXiv, doi: arXiv:2006.11239.

The rendering module preferably is a gaussian splatting model or a neural radiance fields model. A suitable gaussian splatting model is e.g. suggested by J. Chung et al., in “LucidDreamer: Domain-free Generation of 3D Gaussian Splatting Scenes” in 2023, available on arXiv, doi: arXiv:2311.13384. On the other hand, a neural radiance field model was suggested by B. Mildenhall et al. in “NeRF: Representing Scenes as Neural Radiance Fields for View Synthesis”, available on arXiv, doi: arXiv:2003.08934.

A preferred embodiment of the suggested method comprises the step of annotating the training data image by using a data annotation model.

Preferably, the data annotation model is a foundation model. The data annotation module may be finetuned with respect to a number of specific predefined indications or labels.

It is of advantage, if multiple, different virtual poses for the sensor are chosen.

According to another preferred embodiment, the method according to the present invention further comprises the step of adding the virtual image to the 3D point cloud. It is as well possible to choose multiple virtual poses, at least a first and a second virtual pose and to add all virtual images corresponding to all poses to the 3D point cloud. That way, a full representation of a scene may be obtained.

The method according to the present invention and according to any of the embodiments described preferably is used for training of a function implemented by using a machine learning model, in particular for training of a machine learning model used to implement an ADAS function in a vehicle. ADAS is short for advanced driver assistance system. Such advanced driver assistance systems (ADAS) for vehicles are based on a processing of various data sensed by various ADAS sensors, such as radar, LiDAR and ultrasonic sensors as well as cameras. By means of the ADAS sensors, information relating to an environment of the vehicle can be obtained which in turn is used to realize or implement various ADAS functions. ADAS functions on the one hand may include an assistance for the driver while control of the vehicle remains with the driver. On the other hand, depending on the level of automation, a full autonomously driving vehicle may be realized where ADAS functions are automatically implemented. Known ADAS functions, for instance, are various methods for detecting and/or classifying objects and/or obstacles in the vicinity of the vehicle, methods for lane detection and/or lane departure, methods for rain detection or also various parking assistance functions. Once these functions are performed, the results can be used to control a vehicle either manually or automatically (e.g., using electronic control signals to control vehicle components).

The objective problem underlying the present invention is further solved by a computer program comprising instructions, which, when the program is executed by a computer, cause the computer to carry out the method according to the present invention and according to any of the embodiments described, and by a computer-readable (storage) medium comprising instructions executable by at least one processor to perform the method according to any of the embodiments described or on which the computer program according to the present invention is stored.

Finally, the objective technical problem underlying the present invention is as well solved by a training data set for training a machine learning model, preferably comprising at least one neural network, generated by the method according to the present invention and according to any of the embodiments described.

As mentioned, the invention and its preferred embodiments will be described in more detail based on the subsequent figures.

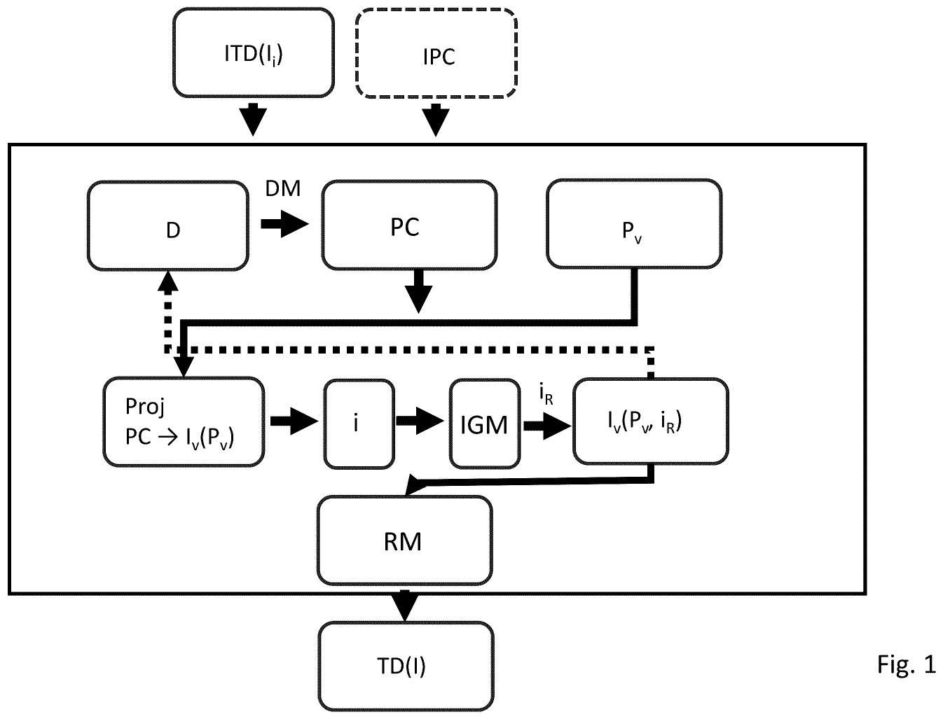

FIG. 1 shows a first preferred embodiment of the method according to the present invention;

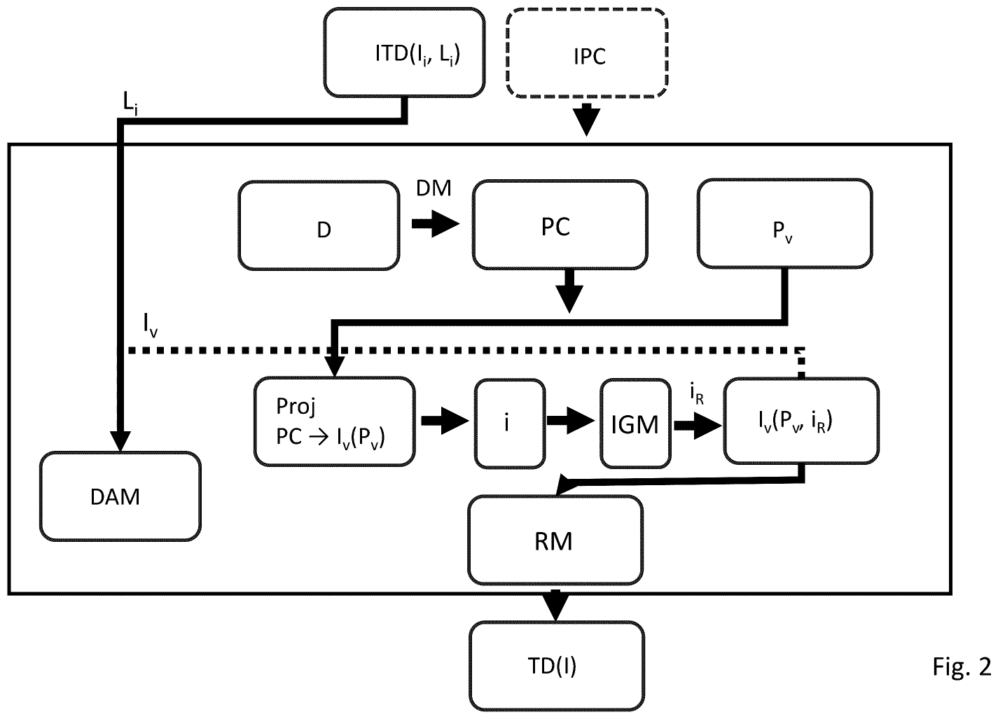

FIG. 2 illustrates a second preferred embodiment of the method according to the present invention; and

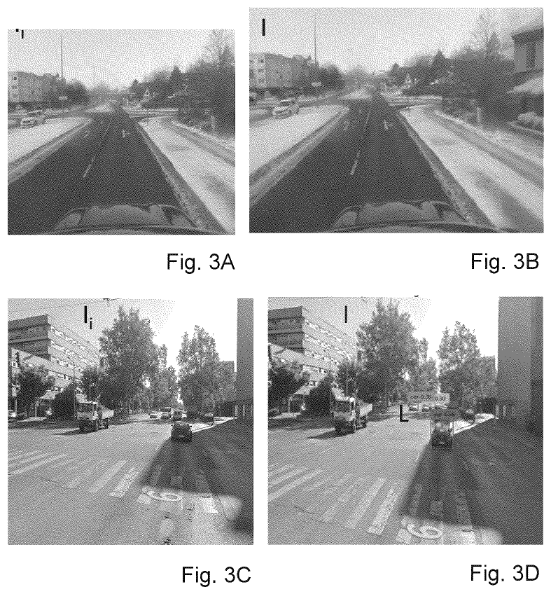

FIGS. 3A, 3B, 3C, and 3D show two examples of input training images and corresponding training data images.

In the figures, the same elements are always provided with the same reference symbols.

Without loss of generalization, the following description relates to an input training data set recorded by a sensor in the form of a vehicle camera. Typically, a camera or multiple cameras are mounted on a vehicle. The collection of training data sets is demanding in view of the time needed to record the data set and costly. Disadvantageously, the recorded training data sets typically can only be used to train machine learning models relating to the specific sensor set up and installation. For instance, a training data set recorded for a normal vehicle may not be suitable for a machine learning model of a truck.

The present invention allows for a transformation of existing input data sets to predefined new virtual camera poses and thus enables to produce new training data sets that fit to different set ups of the camera(s). The input training data set may be transformed to various camera poses and may be used as if training data sets were recorded from the respective camera poses. Accordingly, new training data sets may be generated, and machine learning models, e.g. for implementing ADAS functions, may be (re-)trained using the new training data sets.

In FIG. 1 a block diagram of a preferred embodiment of the method according to the present invention is shown. An input training data set ITD comprising multiple input trainings images Iᵢ, recorded by a camera serves as a basis for generating a training data set TD.

Optionally, an additional, corresponding input point cloud data IPC set may also be taking into account as indicated by dashed lines. By means of the suggested method each input training image Iᵢ is processed so as to derive a virtual image Iᵥ of so created training data set I.

A first step of the method comprises determining a depth map DM which corresponds to the input training image li by using a depth model D. The depth model may comprise at least one neural network and may be a state of the art, especially pretrained, depth model, for instance a monodepth model. If available, the depth model may also take into account the input point could data set. This might improve the depth estimation accuracy.

Taking into account the depth map DM, a 3D point cloud PC is generated. For generating the 3D point cloud PC, intrinsic parameters of the camera may as well be taken into account. In addition, at least one first virtual pose Pv for the camera is chosen. The first virtual post Py is different from a base pose P of the camera used to record the input training data set ITD.

Subsequently, the 3D point cloud PC is projected Proj to a virtual image Iᵥ corresponding to the first virtual pose Pᵥ. The virtual image Iv will comprise image areas i with missing or insufficient point cloud PC information. Among others, this is due to the fact that certain areas of the vehicle environment may not have been in the field of view of the camera when recording the input training data set ITD.

However, in order to produce a full and high-quality virtual image Iᵥ , those image areas i with missing or insufficient information are determined and provided to an image generation model IGM embodied to determine a replacement image area i_{R} based on the image area i.

Optionally, the image generation model may be equipped with an inpainting function. Alternatively, such inpainting process may also optionally separately be provided.

Also optionally, at least one prompt may be provided to the image generation model IGM, the prompt defining a condition to determine the replacement image area i_{R}. That way, the replacement image area i_{R} may be matched to the scene shown in the virtual image Iᵥ. Prompts may then also be determined in an (semi) automated manner, e.g., by using an image-to-text model which is embodied to provide based on the virtual image Iᵥ, a description of the scene depicted therein. The prompt may then be derived from the provided description.

This virtual image Iᵥ is finally provided to a rendering model RM embodied to create a training data image I therefrom. All created training data images I then form part of the created training data set TD. By means of an inpainting process the virtual image Iᵥ may be modified by inserting or deleting certain parts with high correlation to the surrounding of that image part. The inpainting process may preferably be applied to the determined image areas i.

The rendering model RM serves to create a photorealistic training data image I based the virtual image Iᵥ. It is possible, to further apply a postprocessing step of inpainting to the training data image I if it still contains certain pixels or pixel areas with missing or insufficient information.

Optionally, the created virtual images Iᵥ may again be subjected to the depth model D and added to the 3D point cloud PC as indicated by the dashed error. Multiple input training data set images Iᵢ and virtual images Iᵥ may be concatenated in the 3D point cloud TD in order to obtain a 3D representation of the entire vehicle environment. In addition, individual point clouds may also be combined, e.g. by using an iterative closest point method.

FIG. 2 refers to another preferred embodiment, in which at least parts of the input training data set comprise labels Lᵢ. In this case, the virtual images Iᵥ or the training data images I respectively, may be relabeled or reannotated by using a data annotation model DAM. The data annotation model DAM may be a foundation model, e.g. finetuned on the specific labels Lᵢ, e.g. those of the input training data set ITD.

In FIGS. 3A, 3B, 3C, and 3D, finally two examples of corresponding input training data images and training images are shown which refer to two different scenes and two different transformations of the camera pose P.

In FIG. 3A, a first input training image Ii is shown, whereas FIG. 3B refers to a corresponding training data image I. In the image I of FIG. 3B, an image area I on the right side which was not depicted in the input training image Iᵢ is visible which shows a house. The image area i showing the house was generated by the image generation model IGM.

The input training image Iᵢ of FIG. 3C shows a scene of a road ahead of an ego vehicle. In the corresponding training data set image I shown in FIG. 3D, result of a virtual rotation and elevation of the camera, shows additional details of houses on the right side of the image, which have not been visible in the original image Ii. Again, this additional image area i is generated by the image generation model IGM. Moreover, for the images Iv and I, also a data annotation model DAM was used resulting in labels L for cares visible in the training data image of FIG. 3D are shown.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A computer-implemented method, for producing a training data set (TD) based on an input training data set (ITD) comprising multiple input training images (Iᵢ) obtained from at least one sensor, the method comprising for each input training image (Iᵢ) the steps of:
determining a depth map (DM) corresponding to the input training image (Iᵢ), and determining a three-dimensional point cloud (PC) based on the depth map (DM);
choosing at least one first virtual pose (Pᵥ) for the sensor which is different to a base pose (P) which corresponds to a pose of the sensor for recording the input training data set (ITD);
projecting (Proj) the point cloud (PC) to a virtual image (Iᵥ) corresponding to the first virtual pose (Pᵥ)
determining at least one image area (i) of the virtual image (Iᵥ) with missing or insufficient point cloud (PC) information, and replacing the at least one determined image area (i) by a replacement image area (i_{R}) generated by using a generative image generation model (IGM);
obtaining a training data image (I) of the training data set (TD) by using an image rendering model (RM) based on the virtual image (Iᵥ).

2. The method according to claim 1, wherein the depth map (DM) is determined by additionally taking into account an input point cloud dataset corresponding to the input training data set (ITD).

3. The method according to claim 1, comprising the step of applying an inpainting process to the virtual image (Iᵥ) and/or to the training data image (I).

4. The method according to claim 1, wherein the depth map (DM) is determined by using a depth model (D), preferably a monodepth model.

5. The method according to claim 1, comprising the step of annotating the training data image (I) by using a data annotation model (DAM).

6. The method according to claim 5, wherein the depth model (D), the image generation model (IGM), the image rendering model (RM) and/or the data annotation model (DAM) comprise at least one neural network.

7. The method according to claim 1, wherein the image generation model (IGM) is a latent variable generative model, preferably a score-based generative model such as a stable diffusion model.

8. The method according to claim 1, wherein the rendering model (RM) is a gaussian splatting model or a neural radiance fields model.

9. The method according to claim 5, wherein the data annotation model (DAM) is a foundation model.

10. The method according to claim 1, wherein multiple, different virtual poses (Pᵥ) for the sensor are chosen.

11. The method according to claim 1, further comprising the step of adding the virtual image (Iv) to the three-dimensional point cloud (PC).

12. The method of claim 1, wherein the method is utilized for training of a function implemented by using a machine learning model to implement an ADAS function.

13. The method of claim 1 wherein the training data set is used for training a machine learning model comprising at least one neural network.

14. A computer program comprising instructions, which, when the program is executed by a computer, cause the computer to carry out the method of claim 1.

15. A computer-readable storage medium comprising instructions executable by at least one processor to perform the method of claim 1.
